(19) United States
(12) Patent Application Publication
(10) Pub. No.: US 2003/0137481 A1
(43) Pub. Date: Jul. 24, 2003

(54) Driver of display device

(76) Inventor: Yasuhiro Nishida, Nara-shi (JP)

Correspondence Address: HARNESS, DICKEY & PIERCE, P.L.C., P.O. BOX 8910, RESTON, VA, 20195, US

(21) Appl. No.: 10/321,530

(22) Filed: Dec. 18, 2002

(30) Foreign Application Priority Data
Jan. 18, 2002 (JP) 2002-10203

(51) Int. Cl. G09G 3/36

(52) U.S. Cl. 345/100

(57) ABSTRACT

A driver of a display device including two or more display driving sections which share a display screen to perform display control, respectively, the display driving sections each including a setting storage section for storing a mode setting value given by an external controller and a driving voltage generating section for generating a display driving voltage, wherein during display processing, at least one of the display driving sections stores a mode setting value for a master mode to run in the master mode and the other display driving sections receive a driving signal and a driving voltage given by the display driving section running in the master mode to operate in the slave mode.

According to the present invention, switching between the master mode and the slave mode can be performed easily and the need of switching terminals that have been used is eliminated. Therefore, the component count and the number of wiring lines contained in the package are reduced, which leads to reduction in cost.

### CROSS-REFERENCE TO RELATED APPLICATION

This application is related to Japanese Patent Application No. 2002-010203 filed on Jan. 18, 2002, whose priority is claimed under 35 USC § 119, the disclosure of which is incorporated by reference in its entirety.

### BACKGROUND OF THE INVENTION

1. Field of the Invention

The present invention relates to a driver of a display device. In particular, it relates to a driver which allows switching between a master mode and a slave mode of a liquid crystal driver for controlling display on a liquid crystal display panel.

2. Description of Related Art

FIG. 6 shows a block diagram illustrating a known driver of a liquid crystal display device. This is a dual-scan driver of a liquid crystal display device in which two segment electrodes are used for a liquid crystal display (LCD) panel to divide the LCD panel into an upper half region and a lower half region and both regions are driven at the same time.

Especially in a small size liquid crystal display panel, separate liquid crystal drivers (102a, 102b) are often used to drive the two regions individually.

Referring to FIG. 6, the liquid crystal drivers 102a and 102b include control logics 111a and 111b, display data RAMs 112a and 112b, liquid crystal driving voltage generating/boosting circuits 114a and 114b, segment drivers 113a and 113b and common drivers 115a and 115b, respectively.

The liquid crystal driver 102a drives an upper half region of an LCD panel 110, while the liquid crystal driver 102b drives a lower half region of the same.

Each of the liquid crystal drivers is connected to an external microcomputer MPU 120 through a BUS. Display data and a display control signal are input through an I/O control section (not shown) in the control logic 111 of the liquid crystal driver under the control of the MPU 120. Based on the display control signal given by the MPU 120, the control logic 111 writes and reads the display data in and from the display data RAM 112 to control an output of gray scale display data to the LCD panel 110 through the segment driver 113.

Further, the control logic 111 controls the segment driver 113 by various control signals (e.g., an operating clock, a data latch signal, a horizontal synchronizing signal, an alternating signal, a start pulse signal and the like) and also controls the common driver 115 by various control signals (e.g., a horizontal synchronizing signal, an alternating signal and the like). The segment driver 113 outputs a liquid crystal driving voltage including a gray scale display pulse to a terminal of the LCD panel 110 placed on the segment driver side, while the common driver 115 outputs a liquid crystal driving voltage for scanning to a terminal of the LCD panel 110 on the common driver side. The display data RAM 112 stores data for display on the LCD panel.

As shown in FIG. 7, the liquid crystal driving voltage generating/boosting circuit 114 includes a booster circuit 121 for raising a logic voltage Vcc to V0 which is a maximum applied voltage for the LCD panel 110. The output V0 from the booster circuit 121 is divided by dividing registers R connected in series to generate voltages (liquid crystal driving voltages V0, V1, V2, V3, V4 and V5) required for driving the liquid crystal.

FIG. 7 illustrates an example in which the liquid crystal driving voltage generating/boosting circuit 114 boosts the voltage to positive. However, the voltage may be boosted to negative.

Since the liquid crystal driving voltage generating/boosting circuit 114 drives the terminal on the segment driver side which is highly capacitive, low impedance is required. Further, an analog circuit such as an operational amplifier having a voltage follower property is used. Therefore, the circuit generally consumes a large amount of power.

From this point of view, the booster circuit 121 is provided with a setting terminal which stops the operation of the booster circuit when it is unnecessary. For example, the setting terminal is turned to HIGH level to operate the booster circuit 121, while it is turned to LOW level to stop the booster circuit 121.

In a state where the booster circuit 121 is stopped, an output stage thereof enters the high impedance state, so that no inconvenience is caused even if V0 is applied from another circuit.

Thus, the liquid crystal driving voltage is generated by the liquid crystal driving voltage generating/boosting circuit 114. However, it is ineffective to generate the voltage separately by two liquid crystal drivers. Therefore, in general, the voltage is generated by the liquid crystal driving voltage generating/boosting circuit in one of the liquid crystal drivers and given to the other liquid crystal driver.

Referring to FIG. 6, reference numerals 108a and 108b each signify the setting terminal of the booster circuit 121. As mentioned above, the operation of the booster circuit 121 is controlled by the output from the terminal.

Here, it is specified that the liquid crystal driver 102a is in a master mode when the liquid crystal driving voltage generating/boosting circuit 114a of the liquid crystal driver 102a is put into an operating state by the output of the setting terminal 108a.

On the other hand, it is specified that the liquid crystal driver 102b is in a slave mode when the liquid crystal driving voltage generating/boosting circuit 114b of the liquid crystal driver 102b is not operated and a liquid crystal driving voltage is externally applied to the liquid crystal driver 102b.

As shown in FIG. 6, a wiring 103 is provided to supply the liquid crystal driving voltage from the liquid crystal driving voltage generating/boosting circuit 114a of the liquid crystal driver 102a in the master mode to the liquid crystal driving voltage generating/boosting circuit 114b of the liquid crystal driver 102b in the slave mode.

The liquid crystal driving voltage generated by the liquid crystal driving voltage generating/boosting circuit 114a of the liquid crystal driver 102a in the master mode is supplied to the segment driver 113a of the liquid crystal driver, 102a, and also to the liquid crystal driving voltage generating/boosting circuit 114b of the liquid crystal driver 102b in the slave mode through the wiring 103.

Further, the liquid crystal driver 102a in the master mode generates or outputs a synchronizing clock, a signal for synchronizing the two liquid crystal drivers and the like, to supply them to the control logic 111b of the liquid crystal driver 102b in the slave mode.

Japanese Unexamined Patent Publication No. HEI 6 (1994)-274134 describes a one-chip microcomputer having an integrated liquid crystal display driver. According to this publication, two or more one-chip microcomputers for driving the liquid crystal at low output are used and different programs are installed therein such that the microcomputers run in the master mode or the slave mode. Thereby, a single liquid crystal display panel is driven by two microcomputers.

Further, Japanese Unexamined Patent Publication No. HEI 10 (1998)-62746 describes a method for driving liquid crystal and a liquid crystal driver. The liquid crystal driver includes a vertical master driver and a vertical slave driver corresponding to the common driver and only the vertical master driver is provided with a level shifter. The level shifter converts a low voltage signal to a high voltage signal to supply it to both drivers, which eliminates the need of a level shifter circuit.

According to the prior liquid crystal driving circuits, however, the liquid crystal driver in the master mode and that in the slave mode cannot be constituted of a single circuit. Therefore, it is necessary to design the drivers separately, develop programs for the master mode and the slave mode, respectively, or provide a terminal for switching the circuits. That is, the component count of the circuits increases and the number of man-hours to develop the programs increases, which leads to an increase in cost.

If the setting terminal 108 for switching is provided, the voltage thereof needs to be fixed to a Vcc or GND level at implementing on the LCD panel or packaging. For example, in an implement package TCP, wiring connected to a Vcc or a GND needs to be manufactured separately, which increases the cost.

Further, in the case where the liquid crystal driver in the master mode generates power and a control signal and supplies them to the liquid crystal driver in the slave mode, the liquid crystal driver in the master mode can be controlled by a signal from the MPU, whereas the control of the liquid crystal driver in the slave mode is difficult by the MPU in some cases.

For example, in order to initialize the internal circuits by giving a command, the circuits of the liquid crystal drivers need to be actuated and an operating clock is required. In the master liquid crystal driver, the initialization is easily carried out because the operating clock is internally oscillated or externally input. In the slave liquid crystal driver, however, the operating clock is given by the master liquid crystal driver. Therefore, to perform the initialization by giving a command, the master liquid crystal driver is first actuated, the operating clock is output, and then the command for initialization is sent to the slave liquid crystal driver. The initialization in such a manner is difficult to control.

### SUMMARY OF THE INVENTION

The present invention provides a driver of a display device comprising two or more display driving sections which share a display screen to perform display control, respectively, the display driving sections each including a setting storage section for storing a mode setting value given by an external controller and a driving voltage generating section for generating a display driving-voltage, wherein during display processing, at least one of the display driving sections stores a mode setting value for a master mode to run in the master mode and the other display driving sections receive a driving signal and a driving voltage given by the display driving section running in the master mode to operate in the slave mode.

According to the present invention, switching between the master mode and the slave mode can be performed easily and the need of switching terminals that have been used is eliminated. Therefore, the component count and the number of wiring lines contained in the package are reduced, which leads to reduction in cost.

Further, since the display driving sections can be switched between the master mode and the slave mode under the control of the external controller, the display driving sections are designed and packaged without any distinction of the master and the slave. Therefore, commonality in structure is given to the display driving sections and the cost reduction is expected.

The present invention also provides a driver of a display device comprising two or more display driving sections which share a display screen to perform display control, respectively, the display driving sections each including a setting storage section for storing a mode setting value given by an external controller and a driving voltage generating section for generating a display driving voltage, wherein a first display driving section storing a mode setting value for a master mode actuates the driving voltage generating section in itself and outputs a driving signal signifying drive permission or drive prohibition and a driving voltage to the other display driving sections, and the display driving sections which store a mode setting value for a slave mode or have received the driving signal signifying drive prohibition stop the actuation of their driving voltage generating sections and perform predetermined display processing using the driving voltage given by the first display driving section.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a block diagram illustrating a structure of an embodiment of a driver of a liquid crystal display device according to the present invention;

FIG. 2 is a schematic circuit diagram of a liquid crystal driving voltage generating/boosting circuit according to the present invention;

FIG. 3 is a diagram illustrating the state of display on an LCD panel according to the present invention;

FIG. 4 is a diagram illustrating the state of display on the LCD panel according to the present invention;

FIG. 5 is a diagram illustrating the state of display on the LCD panel according to the present invention;

FIG. 6 is a block diagram illustrating a driver of a liquid crystal display device according to the prior art; and

FIG. 7 is a schematic circuit diagram of a liquid crystal driving voltage generating/boosting circuit according to the prior art.

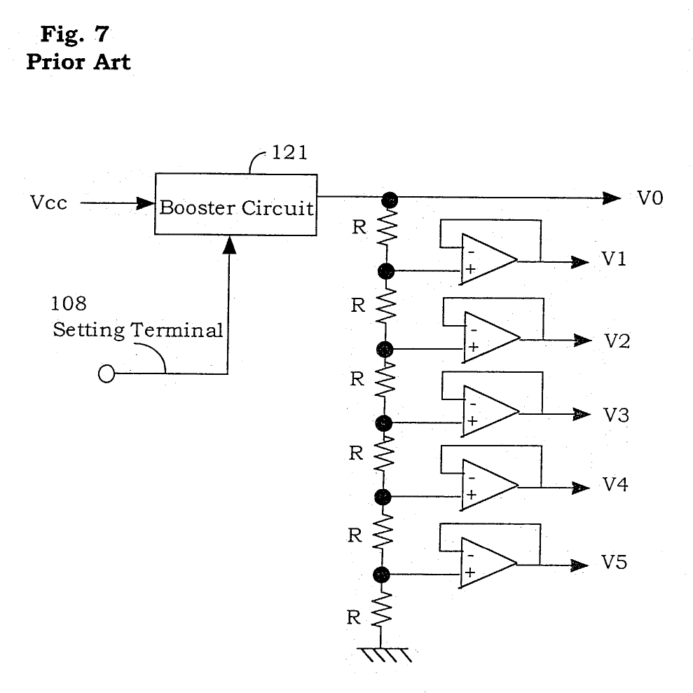

### DESCRIPTION OF THE PREFERRED EMBODIMENTS

The present invention provides registers (setting storage section) for storing mode setting values with a driver of a liquid crystal display device including a liquid crystal driver for the master mode and a liquid crystal driver for the slave mode, for the sake of giving commonality to the packages, reducing the number of wiring lines in the package, reducing the number of switching terminals and cutting the costs.

According to the present invention, the mode setting value stored in the setting storage section can be rewritten by a control signal given by the external controller. For example, the mode setting value is stored in a semiconductor memory such as a register.

Further, the driving voltage generating section may include an output permission judging section for judging from a control signal given by the external controller whether the driving voltage is output or not.

The driver according to the present invention is especially used to drive a liquid crystal display panel.

According to the present invention, the display driving sections function to give display data and a scanning signal to a display panel. It is possible to control the whole region of a single display panel by a single display driving section. However, in the present invention, the display panel is divided into some regions and the display driving sections for display control are provided for each region. That is, the display driving sections perform display control on the display panel by taking charge of the regions, respectively.

For example, a liquid crystal display (LCD) panel is used as the display panel and the display control is performed by dividing the panel into an upper half region and a lower half region, the display driving sections (hereinafter referred to as liquid crystal drivers) for taking charge of the upper half region and the lower half region, respectively, are provided.

According to the present invention, any one of the plural display driving sections is put into the master mode to carry out display operations, while the other display driving sections are put into the slave mode with a view of reducing power consumption. Each of the display driving sections includes a segment driver for giving a display data signal to the display panel, a common driver for giving a scanning signal to the display panel, a display data RAM for temporarily storing display data and a control logic for controlling these circuit elements, so as to perform display on an assigned display region. Moreover, a feature of the display driving sections is that each of them includes a setting storing section which is comprised of a register for storing data (a mode setting value) signifying the master mode or the slave mode.

The display driving sections each include a driving voltage generating section. The driving voltage generating section is constituted of a booster circuit, a register for dividing a voltage (V₀) output from the booster circuit and an operational amplifier, such that a required voltage is generated for driving the display panel in response to an input of a logic power source.

From an external controller (e.g., an MPU), information for establishing the mode setting value and various control signals are given to the display driving sections. Examples of the control signals include a reset signal for instructing the display driving sections to perform initialization after turning the power on, a signal for permitting or prohibiting the generation of a driving voltage, a signal for establishing the state of the driver such as a boost level and the like.

The display driving section put into the master mode can give a driving signal to the display driving section set in the slave mode. Examples of the driving signal include a signal for permitting the generation of the driving voltage, a signal for prohibiting the generation of the driving voltage, a synchronizing signal, an alternating signal and the like.

Using the driving signal, the operations of the display driving section in the slave mode can be controlled by the display driving section in the master mode without directly giving a control signal from the external controller.

The output permission judging section judges from the control signal given by the external controller that the driving voltage generating section should be actuated or stopped. For example, the output permission judging section gives an output permission signal to the driving voltage generating section in accordance with the judgment results.

Embodiment

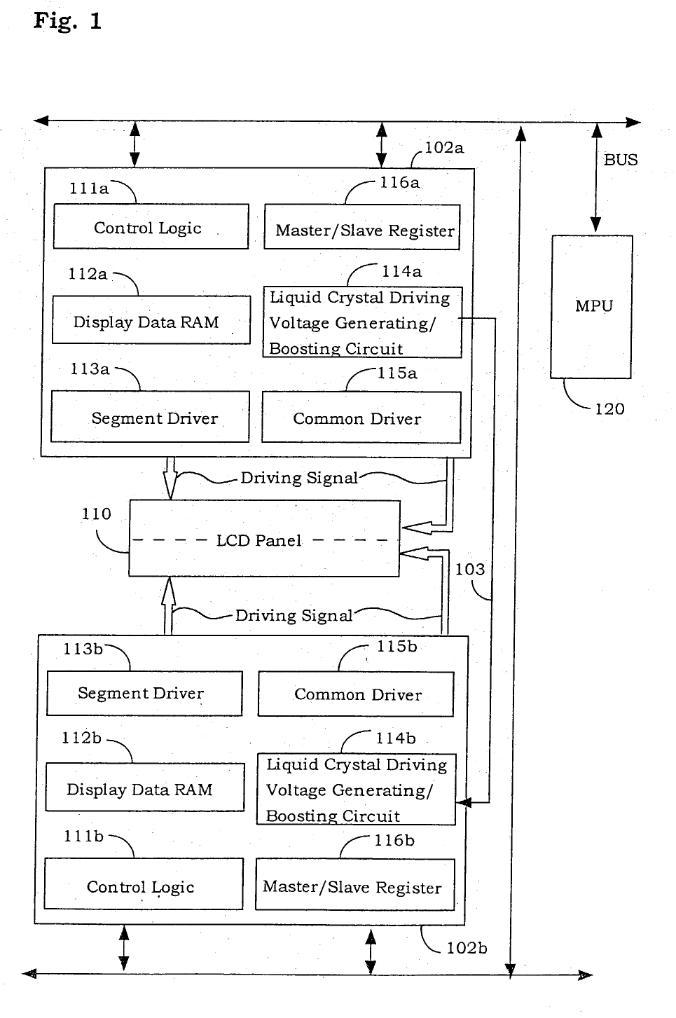

FIG. 1 shows a block diagram illustrating a structure of an embodiment of a driver of a liquid crystal display device according to the present invention.

The driver of the liquid crystal display device is mainly constituted of two liquid crystal drivers 102a and 102b. A feature of the liquid crystal drivers 102a and 102b is that they include master/slave registers (116a, 116b), respectively.

Hereinafter, the master/slave registers may be referred to simply as registers.

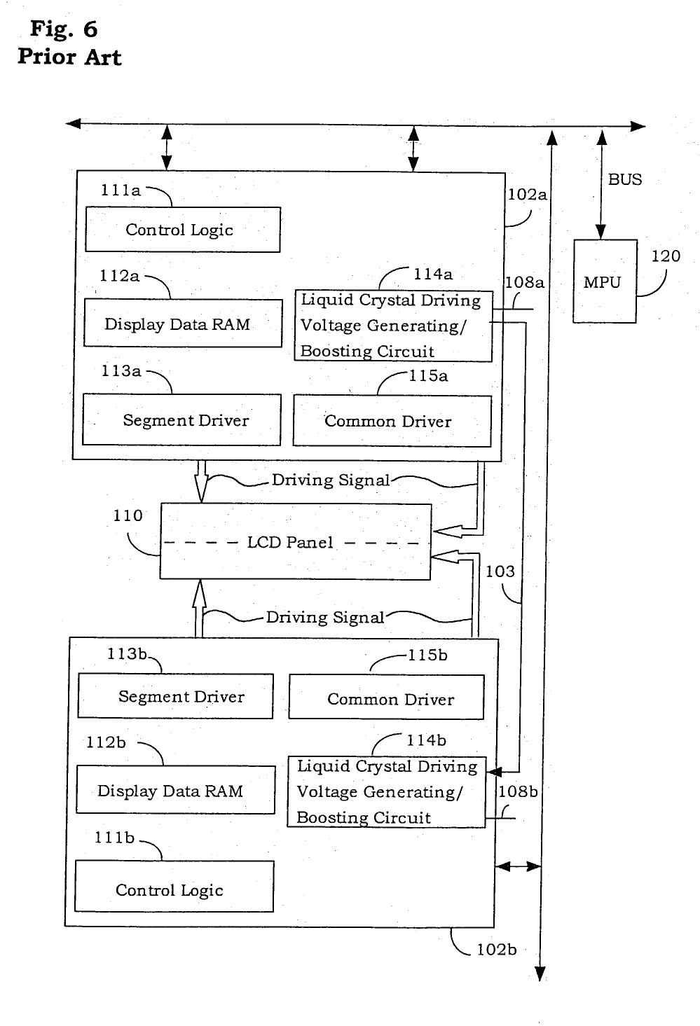

FIG. 1 shows control logics 111a and 111b, display data RAMs 112a and 112b, segment drivers 113a and 113b, liquid crystal driving voltage generating/boosting circuits 114a and 114b, common drivers 115a and 115b, wiring 103, an LCD panel 110, an MPU 120 and a BUS. These elements may have the same structure as those according to the prior art shown in FIG. 6.

One different point from the prior art is that the setting terminal 108 is not provided between the liquid crystal driving voltage generating/boosting circuits 114a and 114b.

The two liquid crystal drivers 102a and 102b can be designed and manufactured to have the same structure without distinction of their driving modes. The modes of the liquid crystal drivers are determined by setting values written in their registers on starting. That is, either of the liquid crystal drivers can be operated in the master mode or the slave mode.

Resistors 116a and 116b are included in the liquid crystal drivers 102a and 102b, respectively, to store a predetermined setting value corresponding to the master mode or the slave mode. General-purpose register elements or flip-flop circuits may be used as the registers 116a and 116b.

To the liquid crystal display drivers 102a and 102b, a setting control signal (command) is given from the external microcomputer MPU 120 through the BUS and an I/O control section which is not shown in FIG. 1. Thereby, a predetermined setting value is written in the registers 116a and 116b, respectively.

For example, the master mode is established by writing a setting value “1” in the register, while the slave mode is selected in reply to a setting value “0”.

The control logic (111a, 111b) of the liquid crystal driver (102a, 102b) reads the setting value stored in the master/slave register (116a, 116b) to judge which mode it should take. According to the judgment results, the control logic drives the LCD panel 110 in the master mode or the slave mode.

Further, as described later, an output permission signal 131 is used to run or stop a booster circuit 121 of the liquid crystal driving voltage generating/boosting circuit 114.

The signal is used to stop the output from the booster circuit 121 to put both of the liquid crystal drivers 102a and 102b into the master mode.

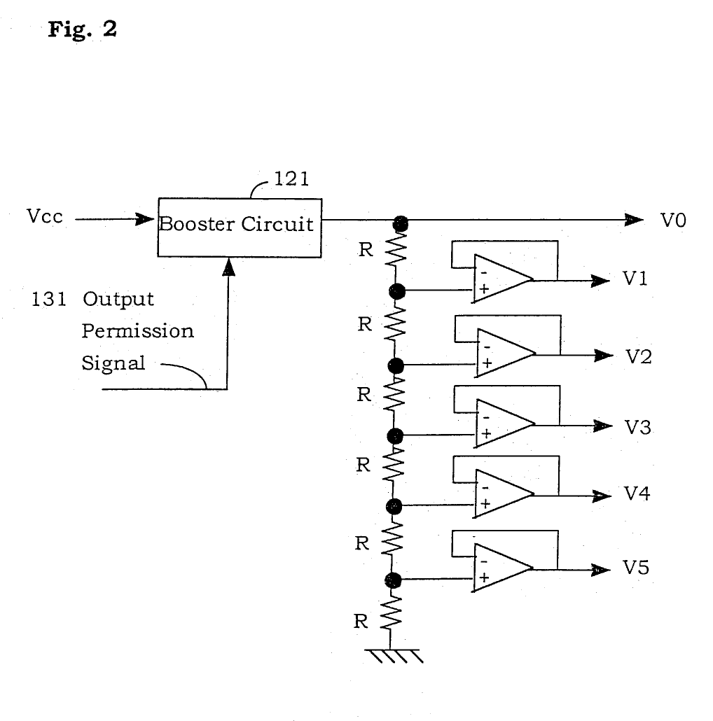

FIG. 2 shows a schematic circuit diagram of the liquid crystal driving voltage generating/boosting circuit 114 according to the present invention.

The liquid crystal driving voltage generating/boosting circuit 114 is the same as those according to the prior art in that the booster circuit 121 is provided and output V₀ is divided by registers R. A difference from the prior art is that the booster circuit 121 is controlled to run or stop by the output permission signal 131 generated in accordance with the setting value stored in the master/slave register.

For example, the booster circuit 121 is put into the operate state when the output permission signal 131 is active (H level), while it enters the suspend state when the output permission signal 131 is grounded (L level).

In the present invention, a setting terminal as used in the prior art may be used, but it is not essential. In this case, an OR is obtained from the output permission signal 131 and a signal from the setting terminal and input to the booster circuit 121.

The liquid crystal driver put into the master mode makes the liquid crystal driving voltage generating/boosting circuit 114 in itself generate a liquid crystal driving voltage and gives the driving voltage through the wiring 103 to the liquid crystal driver in the slave mode.

For example, when “a command for establishing the master mode” and “a command for establishing the slave mode” are given to the liquid crystal drivers 102a and 102b, respectively, from the MPU 120 through the BUS, a setting value for the master mode is written in the liquid crystal driver 102a and a setting value for the slave mode is written in the liquid crystal driver 102b. Then, the liquid crystal driver 102a set in the master mode generates the liquid crystal driving voltage to supply it to the segment driver 113a in itself, and also to the liquid crystal driver 102b in the slave mode through the wiring 103.

The control logic of the liquid crystal driver in the master mode outputs an internally oscillated clock, a synchronizing clock (operating clock) or a control signal input from the external MPU 120 to the liquid crystal driver in the slave mode through the BUS.

The control signal input from the MPU signifies, for example, a start pulse signal, a horizontal synchronizing signal, an alternating signal and the like which are sent in synchronization with the liquid crystal driver in the slave mode.

In reply to a predetermined control signal from the external MPU 120, the control logic of the liquid crystal driver in the master mode may output a signal to the control logic of the liquid crystal driver in the slave mode through the BUS for prohibiting the control logic of the liquid crystal driver in the slave mode from outputting a synchronizing clock and a control signal such as a start pulse signal.

Further, the MPU 120 may write a setting value for the master mode to one of the registers 116a and 116b and a setting value for the slave mode to the other. Alternatively, the MPU 120 may write a setting value for the master mode only in the register of one liquid crystal driver, and then output a driving signal for instructing the liquid crystal driver in the master mode to write a setting value for the slave mode to the other liquid crystal driver through the BUS.

In this case, the task of the MPU 120 is merely writing the setting value for the master mode to one of the liquid crystal drivers, and therefore the load on the MPU is reduced.

As described above, in general use, one of the two liquid crystal drivers is used as the master and the other is used as the slave and the master liquid crystal driver generates the liquid crystal driving voltage. However, it is also possible to permit or prohibit the master liquid crystal driver to generate the liquid crystal driving voltage by giving a predetermined command from the MPU 120 to the master liquid crystal driver.

For example, the master liquid crystal driver is controlled to generate the voltage when it receives a command to generate the voltage, or controlled not to generate the voltage when it receives a command to prohibit the generation of the voltage.

Even if both of the liquid crystal drivers are put into the master mode, one of the liquid crystal drivers is permitted to generate the voltage, whereas the other is prohibited by using the command send from the MPU. Therefore, a short circuit in the wiring 103 between the two liquid crystal driving voltage generating/boosting circuits is prevented.

Further, as described above, a synchronizing clock and a control signal are output from the liquid crystal driver set in the master mode. When both of the liquid crystal drivers are put into the master mode, the MPU 120 may give one of the liquid crystal drivers a predetermined command to permit or prohibit the output of the synchronizing clock so that interference of the synchronizing clocks does not occur.

Next, as shown in FIG. 1, explanation is given of initialization of the driver of the liquid crystal display device provided with the register according to the present invention.

The initialization is processing which is first carried out after turning the power on and signifies the mode setting of the two liquid crystal drivers carried out through a series of operations described below to make the LCD panel ready for driving.

(1) After turning the power on, data signifying the master mode are input in the registers of both liquid crystal drivers and setting is made not to output the synchronizing clock.

(2) Oscillation circuits in both liquid crystal drivers are actuated to generate an operating clock which will be a basic clock. Thereby, the operating clock is supplied to the inside of the liquid crystal drivers.

(3) When a reset command is given from the MPU 120 through the BUS, the liquid crystal drivers carry out a series of operations programmed in advance in the control logic to initialize the state of the internal circuits.

Here, the reset command signifies a reset signal and a series of operations for data writing in the master/slave register.

The previously programmed series of operations may include, for example, initialization of the internal registers, initialization of the internal logic and the like.

The reset command brings both of the liquid crystal drivers into the master mode. However, it is also possible to put one of the liquid crystal drivers into the slave mode so that the reset operations are performed only by giving a clock signal from the master liquid crystal driver to the slave liquid crystal driver.

(4) After the reset command is executed, a setting value signifying the slave mode is written in the master/slave register of one of the liquid crystal drivers. Thereby, hereinafter, one liquid crystal driver functions as the master, while the other acts as the slave.

(5) Then, a value is written by the MPU 120 in the register to establish the setting of the liquid crystal drivers, thereby the liquid crystal drivers enter a state where they are ready to capture a power circuit or the display data and perform display on the liquid crystal screen

Especially, in the master liquid crystal driver, the output permission signal 131 is set active (e.g., H level) to actuate the liquid crystal driving voltage generating/boosting circuit 114 in itself. Then, the generated driving voltage is sent to the slave liquid crystal driver through the wiring 103 to allow the display by the slave liquid crystal driver.

The initialization of the driver of the liquid crystal display device according to the present invention is carried out as described above. After the initialization, the liquid crystal drivers carry out usual operations in the master mode or the slave mode.

Next, an embodiment of the operations of the driver of the liquid crystal display device according to the present invention is explained with reference to the diagrams.

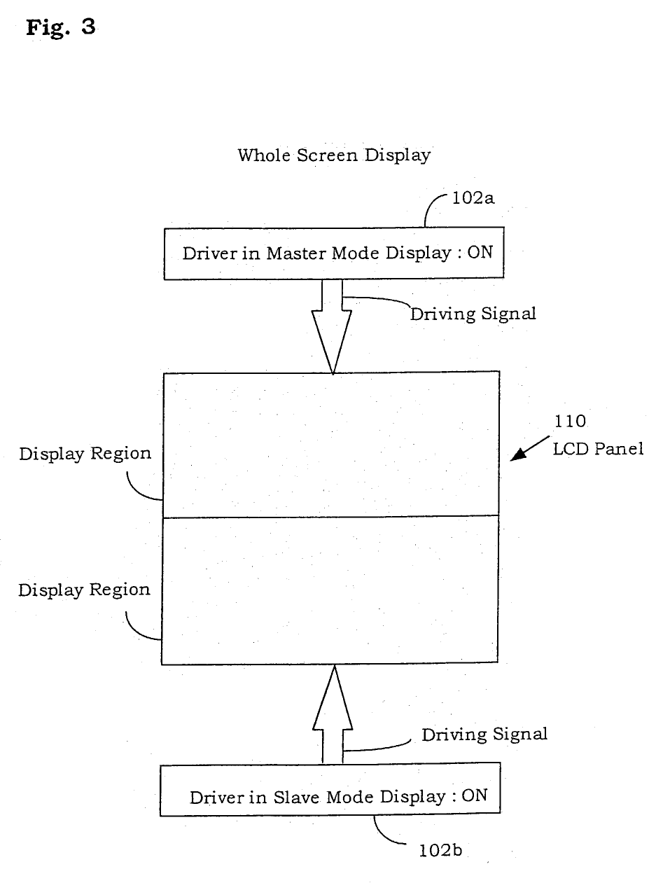

FIG. 3 shows a diagram of the LCD panel in which both of the master liquid crystal driver and the slave liquid crystal driver carry out the display.

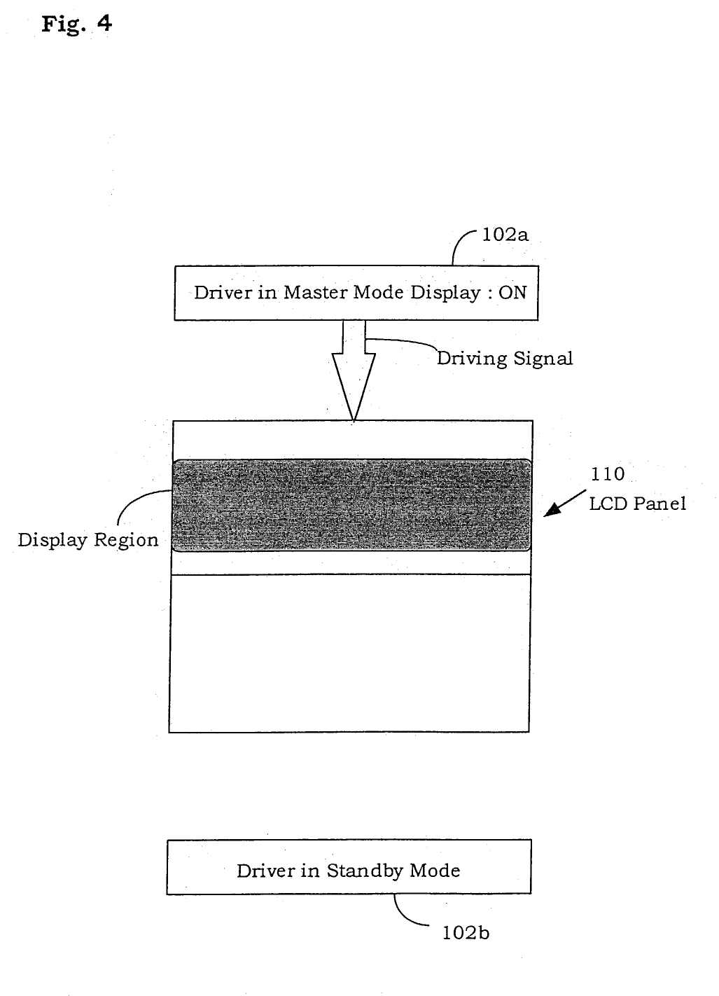

FIG. 4 shows a diagram of the LCD panel in which only the master liquid crystal driver performs the display, while the slave liquid crystal driver does not.

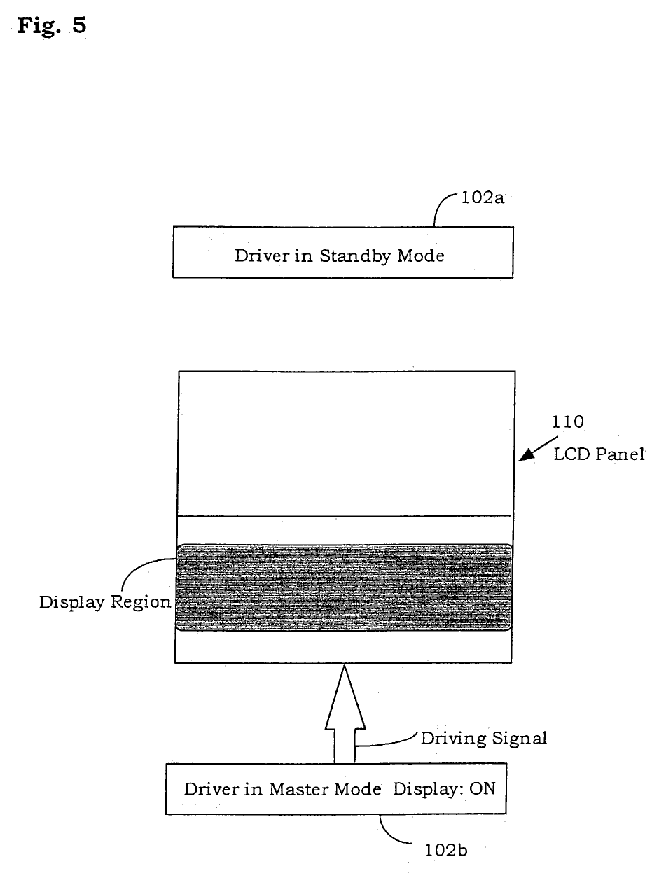

FIG. 5 shows the LCD panel in which, contrast to FIG. 4, the master liquid crystal driver is in a non-display state, while the master liquid crystal driver is in a display state.

In the cases shown in FIG. 4 and FIG. 5, display is performed only on a partial display region of the screen, while liquid crystal in a non-display region is not driven. This is called partial driving.

The partial driving is carried out by giving a scanning signal only to the display region.

First, explanation is given of the partial driving wherein the display state is shifted from the whole screen display shown in FIG. 3 to the display only on a part closer to the master liquid crystal driver 102a shown in FIG. 4.

In this case, the master liquid crystal driver 102a for driving the upper half region of the LCD panel 110 is normally operated, while it prohibits the output of the synchronizing clock and the driving signal that have been sent to the slave liquid crystal driver 102b for driving the lower half region of the LCD panel 110, in response to a control signal from the external MPU 120.

Thereby, the operation of the slave liquid crystal driver 102b is stopped. Since the synchronizing clock and the like are not input, the slave liquid crystal driver 102b enters the standby state, which reduces power consumption.

Next, explanation is given of the partial driving wherein the display state is shifted from the whole screen display shown in FIG. 3 to the display only on the lower half region by the slave liquid crystal driver 102b shown in FIG. 5.

In order to reduce the power consumption, the operation of the master liquid crystal driver 102a needs to be stopped. However, when the master liquid crystal driver 102a is stopped, the slave liquid crystal driver 102b is also stopped. Therefore, it is necessary to change the mode of the slave liquid crystal driver 102b.

First, the liquid crystal driver 102b now in the slave mode is brought into the master mode such that the lower half region of the LCD panel is driven by a liquid crystal driving voltage generated by the liquid crystal driving voltage generating/boosting circuit 114b in the liquid crystal driver 102b.

By setting the liquid crystal driver 102b in the master mode, both of the liquid crystal drivers are brought into the master mode. This state is similar to the initial state described above, and therefore no inconvenience is caused.

Subsequently, the value stored in the register 116a is rewritten to a setting value for the slave mode so that the liquid crystal driver 102a is put into the slave mode and enters the standby state. Thereby, the liquid crystal driver 102a is stopped. This allows the reduction of power consumption.

Thus, according to the present invention, switching between the master mode and the slave mode is carried out easily as needed at actual driving. Further, in the case of partial driving where the display is carried out only on the half region of the LCD panel, the liquid crystal driver in charge of the other half region (non-display region) enters the standby mode and power is not supplied thereto. Therefore, power consumption can be reduced.

According to the present invention, an oscillation circuit and a booster circuit which consume a large amount of power, as well as a voltage generating circuit including an analog circuit to achieve low impedance can be switched between the master mode and the slave mode. Therefore, the present invention is effective in reducing power consumption and cost of a driver of a display device including a plurality of same driving devices or driving circuit blocks.

According to the present invention, the mode switching between the liquid crystal drivers can be carried out during operation in response to the control signal sent from the external controller. Therefore, setting terminals which have been used for the mode switching are not required. Further, a packaging area and the component count are reduced, the circuit can be designed more easily and the cost is reduced. Moreover, the two liquid crystal drivers can be designed and packaged to have the same circuit structure, which also achieves the cost reduction.

Further, in the case of partial driving, only the liquid crystal driver in charge of the non-display region is stopped. Therefore, reduction in power consumption is easily achieved.

What is claimed is:

1. A driver of a display device comprising two or more display driving sections which share a display screen to perform display control, respectively, the display driving sections each including a setting storage section for storing a mode setting value given by an external controller and a driving voltage generating section for generating a display driving voltage, wherein during display processing, at least one of the display driving sections stores a mode setting value for a master mode to run in the master mode and the other display driving sections receive a driving signal and a driving voltage given by the display driving section running in the master mode to operate in the slave mode.

2. A driver of a display device comprising two or more display driving sections which share a display screen to perform display control, respectively, the display driving sections each including a setting storage section for storing a mode setting value given by an external controller and a driving voltage generating section for generating a display driving voltage, wherein a first display driving section storing a mode setting value for a master mode actuates the driving voltage generating section in itself and outputs a driving signal signifying drive permission or drive prohibition and a driving voltage to the other display driving sections, and the display driving sections which store a mode setting value for a slave mode or have received the driving signal signifying drive prohibition stop the actuation of their driving voltage generating sections and perform predetermined display processing using the driving voltage given by the first display driving section.

3. A driver of a display device according to claim 1 or 2, wherein the mode setting value stored in the setting storage section can be rewritten by a control signal given by the external controller.

4. A driver of a display device according to claim 1 or 2, wherein the driving voltage generating section includes an output permission judging section for judging from a control signal given by the external controller whether the driving voltage is output or not.

5. A driver of a display device according any one of claims 1 to 4, which is used to drive a liquid crystal display panel.
